(19) United States
(12) Patent Application Publication
(10) Pub. No.: US 2025/0019210 A1
(43) Pub. Date: Jan. 16, 2025

(54) LATCHING DEVICE FOR SECURING AND MANEOUVERING INDUSTRIAL OR MARINE EQUIPMENT

(71) Applicant: HAWBOLDT INDUSTRIES LTD., Chester (CA)

(72) Inventor: Kayleigh Landers, Bedford (CA)

(21) Appl. No.: 18/350,605

(22) Filed: Jul. 11, 2023

(51) Int. Cl. B66C 1/36; B63B 27/16

(52) U.S. Cl. CPC B66C 1/36; B63B 27/16; B63B 27/10

(57) ABSTRACT

A latching mechanism for securing and maneuvering industrial or marine equipment. The latching mechanism is coupled to a lift and configured for maneuvering a load, and comprises a latch housing, the latch housing comprising a plurality of latch fingers, the latch fingers being configured to move between an open position and a closed position; a bullet assembly, the bullet assembly comprising a shaft, a bullet head and a terminal end, the bullet head being connected to one end of the shaft and the terminal end being connected to the other end of the shaft, and the terminal end being configured to connect to the load; a block, the block being configured to move along the shaft of the bullet assembly between a first position and a second position; each of the latch fingers including a groove, said groove being configured for receiving and holding at least a portion of the block in said second position; the bullet assembly being configured to couple to a tension member, and the tension member being configured to raise and lower the bullet assembly under an applied tension; the bullet head being configured to engage the plurality of latch fingers in a latched mode in response to the applied force on the bullet assembly; the bullet assembly being responsive to a further applied tension to move the block into the second position and engage the groove in the plurality of latch fingers and move the plurality of latch fingers into the open position; and in the open position the latch fingers being configured to allow the bullet head to pass and the block to disengage from the groove and move into the first position, and into an unlatched mode, so that the load attached to the tension member can be maneuvered by the lift.

### FIELD OF THE INVENTION

The present invention relates to a latching device or mechanism and more particularly, to a latching device for securing and maneuvering marine or industrial equipment, and other types of loads, on a ship deck or on a loading platform, or on a factory floor or loading dock, or in other marine or industrial applications.

### BACKGROUND OF THE INVENTION

In the art, there are known latching devices for coupling and maneuvering industrial equipment or loads. Such devices typically utilize hydraulic actuators to actuate, i.e. latch and unlatch, the latching mechanism. The hydraulic actuators rely on signals to control the latching/unlatching functions. However, in the art there have been instances of the hydraulic actuator malfunctioning due to signal issues, leading to dropping of the equipment, for example, on a ship deck or lost into the sea. In addition, such hydraulic actuators entail specific procedures for latching/unlatching and human mistakes can lead to the equipment being dropped or lost. Such actuators can also introduce more complexity and high cost.

Accordingly, there remains a need for improvements in the art.

### BRIEF SUMMARY OF THE INVENTION

The present invention is directed to a latching device or mechanism and more particularly, to a latching device for securing and manipulating industrial equipment and other types of loads, on a ship deck or a loading platform, or in other marine or industrial applications.

According to an embodiment, the present invention comprises a latching mechanism coupled to a lift and configured for maneuvering a load, said latching mechanism comprising: a latch housing, said latch housing comprising a plurality of latch fingers, said latch fingers being configured to move between an open position and a closed position; a bullet assembly, said bullet assembly comprising a shaft, a bullet head and a terminal end, said bullet head being connected to one end of said shaft and said terminal end being connected to the other end of said shaft, and said terminal end being configured to connect to the load; a sliding block, said sliding block being configured to move along said shaft of said bullet assembly between a first position and a second position; each of said latch fingers including a groove, said groove being configured for receiving and holding at least a portion of said sliding block in said second position; said bullet assembly being configured to couple to a tension member, and said tension member being configured to raise and lower said bullet assembly under an applied tension; said bullet head being configured to engage said plurality of latch fingers in a latched mode in response to said applied force on said bullet assembly; said bullet assembly being responsive to a further applied tension to move said sliding block into said second position and engage said groove in said plurality of latch fingers and move said plurality of latch fingers into said open position; and in said open position said latch fingers being configured to allow said bullet head to pass and said sliding block to disengage from said groove and move into said first position, and into an unlatched mode, so that the load attached to said tension member can be maneuvered by the lift.

According to another embodiment, the present invention comprises an industrial lift configured for lifting/lowering a load, said industrial lift comprising: a lift arm, said lift arm being operatively coupled to a lift mechanism for lowering and raising said lift arm; a drive mechanism configured for extending and retracking a tension member; a docking head operatively coupled to one end of the lift arm and being connected to said tension member; said drive mechanism being responsive to one or more control signals for unwinding/rewinding said tension member and for controlling tension and slack in said tension member; a latching mechanism, said latching mechanism including, a latch housing, said latch housing comprising a plurality of latch fingers, said latch fingers being configured to move between an open position and a closed position; a bullet assembly, said bullet assembly comprising a shaft, a bullet head and a terminal end, said bullet head being connected to one end of said shaft and said terminal end being connected to the other end of said shaft, and said terminal end being configured to connect to the load; a block, said block being configured to move along said shaft of said bullet assembly between a first position and a second position; each of said latch fingers including a groove, said groove being configured for receiving and holding at least a portion of said block in said second position; said bullet assembly being configured to couple to said tension member, and said tension member being configured to raise and lower said bullet assembly under an applied tension; said bullet head being configured to engage said plurality of latch fingers in a latched mode in response to said applied force on said bullet assembly; said bullet assembly being responsive to a further applied tension to move said block into said second position and engage said groove in said plurality of latch fingers and move said plurality of latch fingers into said open position; and in said open position said latch fingers being configured to allow said bullet head to pass and said block to disengage from said groove and move into said first position, and into an unlatched mode.

According to a further embodiment, the present invention comprises a latching mechanism coupled to a lift arm and configured for maneuvering a load, said latching mechanism comprising: a lifting head, said lifting head being operatively coupled to the lift arm; a latch housing, said latch housing comprising a plurality of latch fingers, said latch fingers being configured to move between an open position and a closed position; a bullet assembly, said bullet assembly comprising a shaft, a bullet head and a terminal end, said bullet head being connected to one end of said shaft and said terminal end being connected to the other end of said shaft, and said terminal end being configured to connect to the load; a sliding block, said sliding block being configured to move along said shaft of said bullet assembly between a first position and a second position; each of said latch fingers including a groove, said groove being configured for receiving and holding at least a portion of said block in said second position; said bullet assembly being configured to connect to the load; said bullet head being configured to engage said plurality of latch fingers in a latched mode in response to said lifting head and said latch housing being lowered onto said bullet assembly; said bullet assembly being responsive to a further movement of said latch housing and said lifting head to move said sliding block into said second position and engage said groove in said plurality of latch fingers and move said plurality of latch fingers into said open position; and in said open position said latch fingers being configured to allow said bullet head to pass and said sliding block to disengage from said groove and move into said first position, and into an unlatched mode.

Other aspects and features of the present invention will become apparent to those ordinarily skilled in the art upon review of the following description of embodiments of the invention in conjunction with the accompanying figures.

### BRIEF DESCRIPTION OF THE DRAWINGS

Reference will now be made to the accompanying drawings which show, by way of example, embodiments of the present invention, and in which:

FIG. 1 shows in diagrammatic form an exemplary operating environment comprising a ship deck for a latching device according to an embodiment of the present invention;

FIG. 2 shows a partial cut-away view of a latching device according to an embodiment of the present invention taken along cross-sectional line A-A in FIG. 3A;

FIG. 3A shows a latch housing for the latching device of FIG. 2 according to an embodiment of the present invention;

FIG. 3B shows a bullet assembly for the latching device according to an embodiment of the present invention;

FIG. 3C shows a bullet component for the latching device according to an embodiment of the present invention;

FIG. 3D shows a sliding block for the bullet assembly for the latching device according to an embodiment of the present invention;

FIG. 3E shows a side view of a latching finger for the latching device according to an embodiment of the present invention;

FIG. 3F shows an isometric view of the latching finger for the latching device or mechanism according to an embodiment of the present invention;

FIG. 4A shows an exemplary configuration of a latching mechanism according to an embodiment of the present invention for use with a recovery lift or winch on a marine vessel;

FIG. 4B shows the latching mechanism of FIG. 4A in a latched mode, and coupled to a load on the deck of the vessel;

FIG. 4C shows the latching mechanism of FIG. 4B latched to the load and the recovery lift configured in an outboard position from the vessel;

FIG. 4D shows the latching mechanism of FIG. 4C in an unlatched mode with the recovery lift in the outboard position for lowering the load into the water;

FIG. 4E shows another view of the latching mechanism latched to an exemplary load comprising a CTD (Conductivity Temperature Depth (pressure) sensors) rosette;

FIG. 5A shows the latching mechanism in a resting position or state according to an embodiment of the present invention;

FIG. 5B shows the latching mechanism in a pre-latching position or state according to an embodiment of the present invention;

FIG. 5C shows the latching mechanism in a latched or coupled position or state according to an embodiment of the present invention;

FIG. 5D shows the latching mechanism moving in a pre-unlatching position or state according to an embodiment of the present invention;

FIG. 5E shows the latching mechanism in a latching release position or state according to an embodiment of the present invention;

FIG. 5F shows the latching mechanism in an open or unlatched position configured for lowering the load; and

FIG. 6 shows a latching mechanism and configuration according to another embodiment of the present invention.

Like reference numerals indicate like or corresponding elements or components in the drawings.

### DETAILED DESCRIPTION OF THE EMBODIMENTS OF THE INVENTION

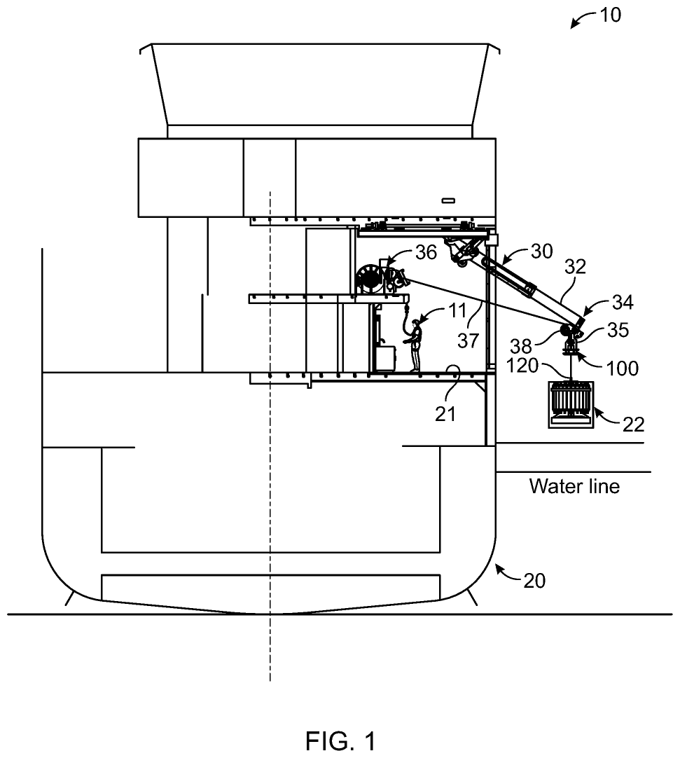

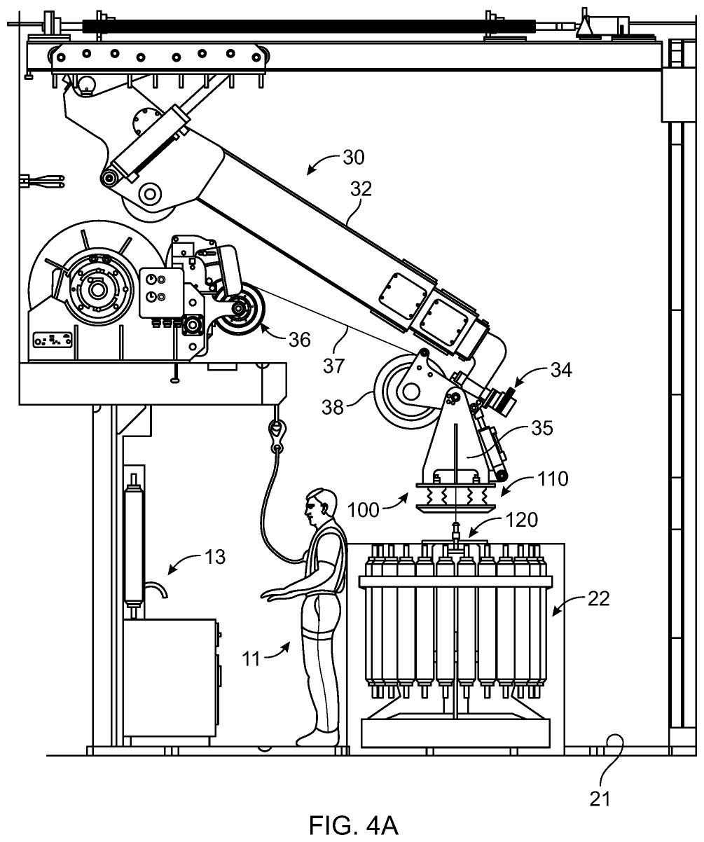

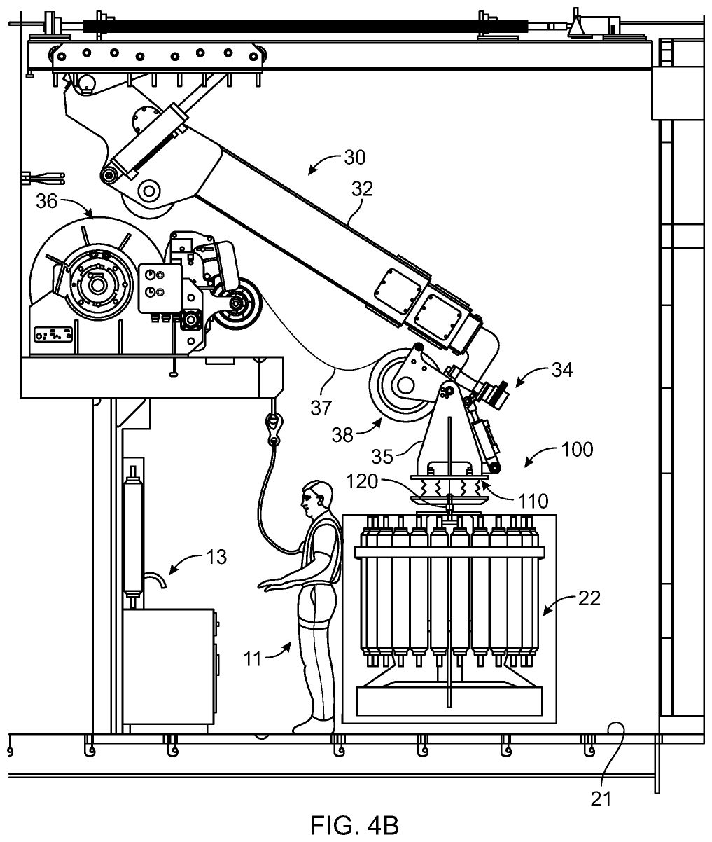

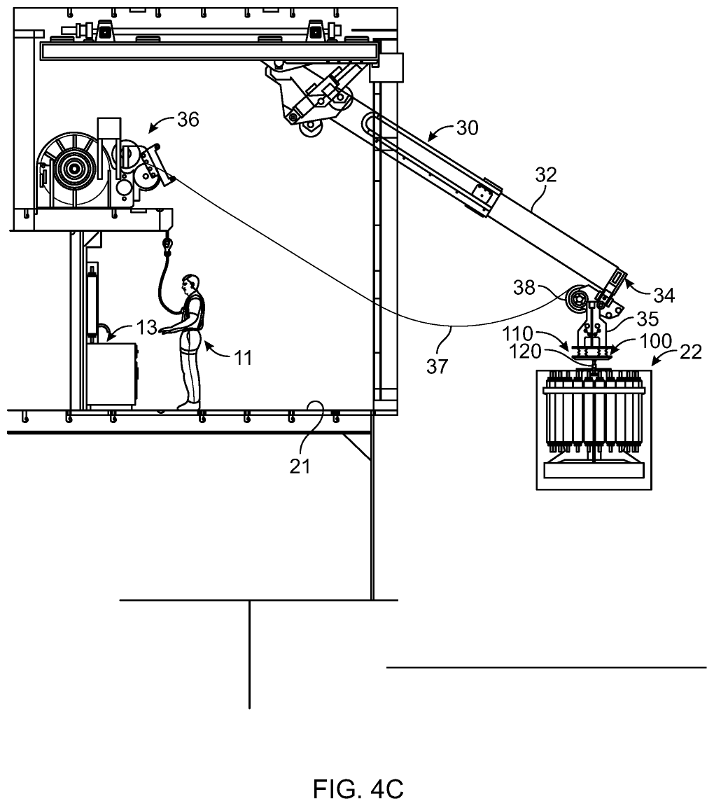

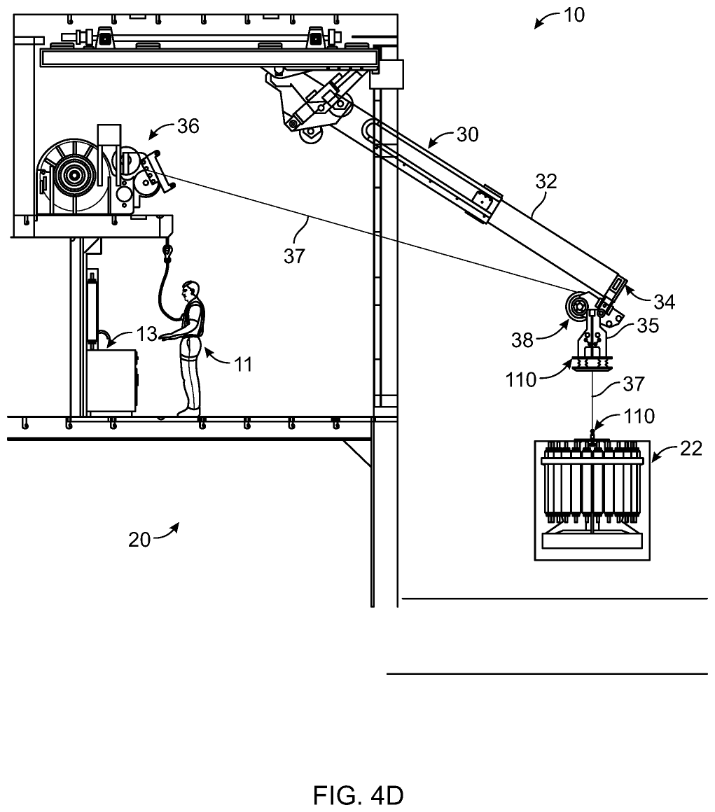

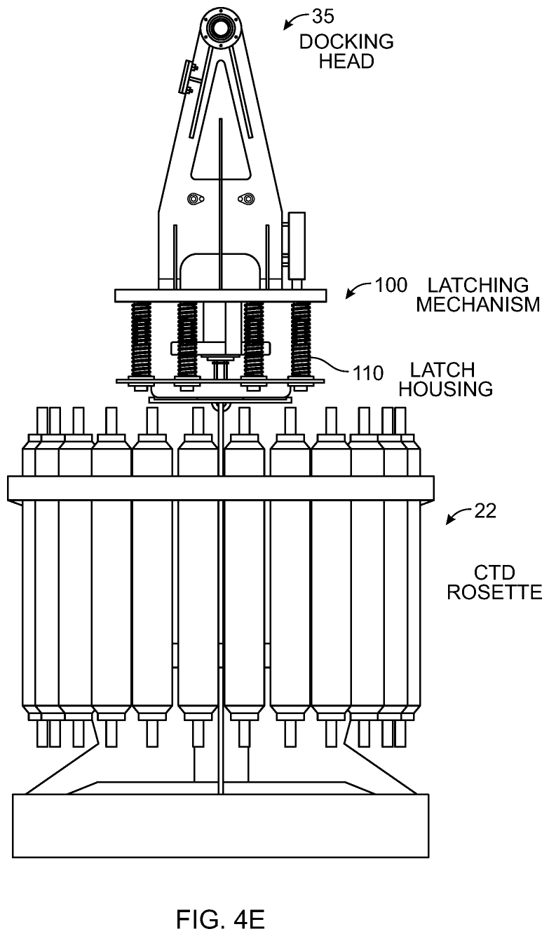

Reference is made to FIG. 1, which shows in diagrammatic form an exemplary operating environment and configuration for implementing and practicing a latching device or mechanism according to embodiments of the present invention. The operating environment according to an embodiment and indicated generally by reference 10 comprises a ship or other marine vessel indicated by reference 20. The ship 20 is configured with a recovery lift or crane indicated generally by reference 30. The recovery lift 30 is installed on a deck or platform 21 on the ship 20. A load, e.g. industrial marine equipment or machinery, indicated generally by reference 22 is loaded or carried on the ship deck 21 as shown. According to an exemplary implementation, the recovery lift or crane 30 comprises a hydraulic actuated and extendible lift arm or beam indicated by reference 32 as shown in FIG. 1 and in more detail in FIGS. 4A and 4B. The extendible lift arm 32 includes a terminal end 34 comprising a docking head 35, which is configured to operatively connect a latching mechanism indicated generally by reference 100, as described in more detail below and for example as shown in FIG. 4E. The lift 30 further includes a cable spindle and drive or winch mechanism indicated generally by reference 36 and a sheave pulley or wheel 38 at the terminal end 34, and configured to extend/retrack, i.e. wind/unwind, a tension member 37 which is coupled to the latching mechanism 100 and the load 22. The tension member 37 may comprise a cable, a rope, a rigid or fixed bar, and the like, as will be within the understanding of those skilled in the art. The cable spindle and drive mechanism 34 and sheave pulley or wheel 38 are configured to control the latching mechanism 100 to engage/disengage the load 22 and lower/raise the load 22, as described in more detail below. In the operation of the latching mechanism 100, an operator 11 controls the location or positioning of the lift 30 and the latching mechanism 100 on the deck or platform 21 of the ship 20, and the latching mechanism 100 is actuated as described in more detail below. While embodiments of the latching mechanism 100 are described in exemplary marine applications or environments, it will be appreciated and understood that the latching mechanism is also suitable in other industrial applications or marine and/or land environments.

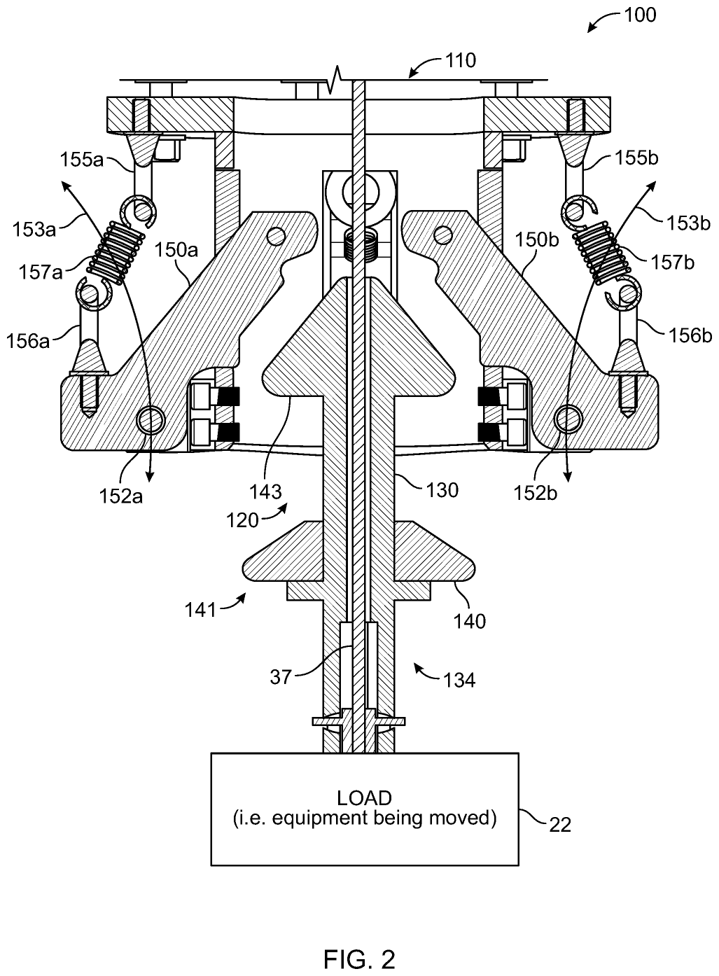

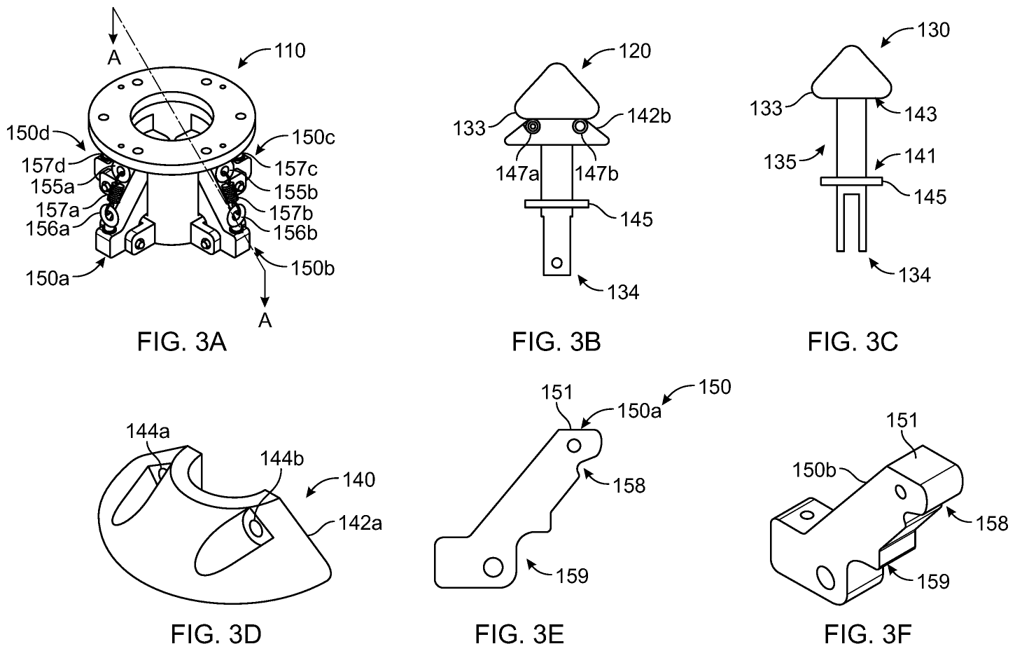

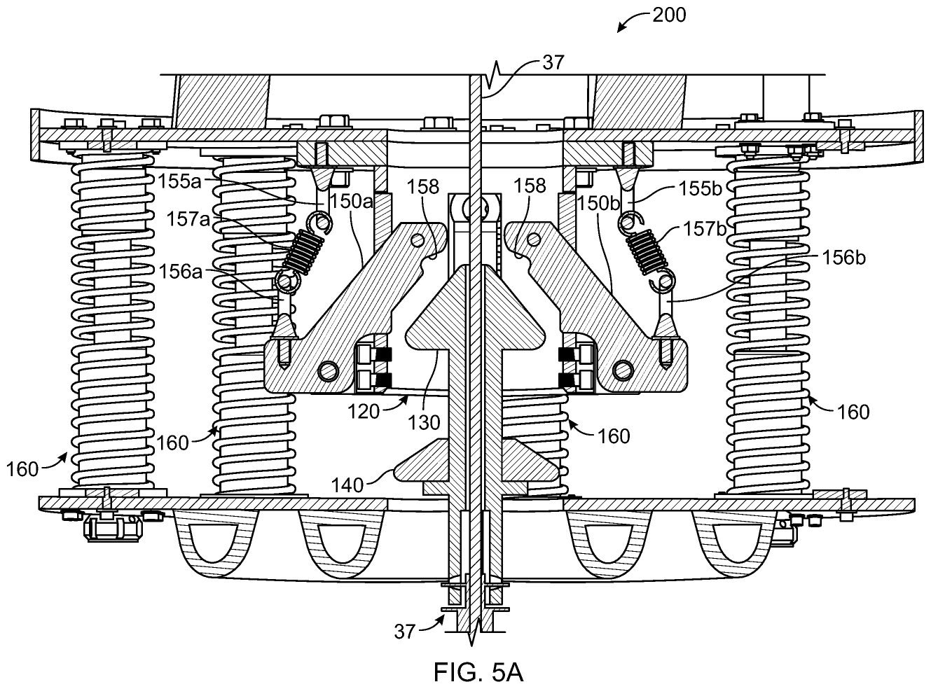

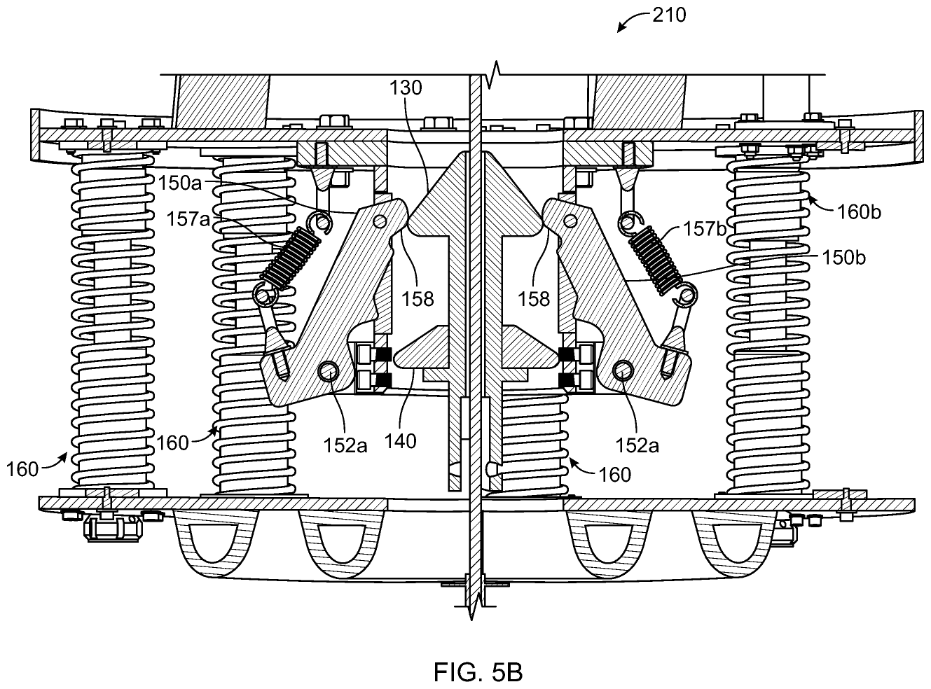

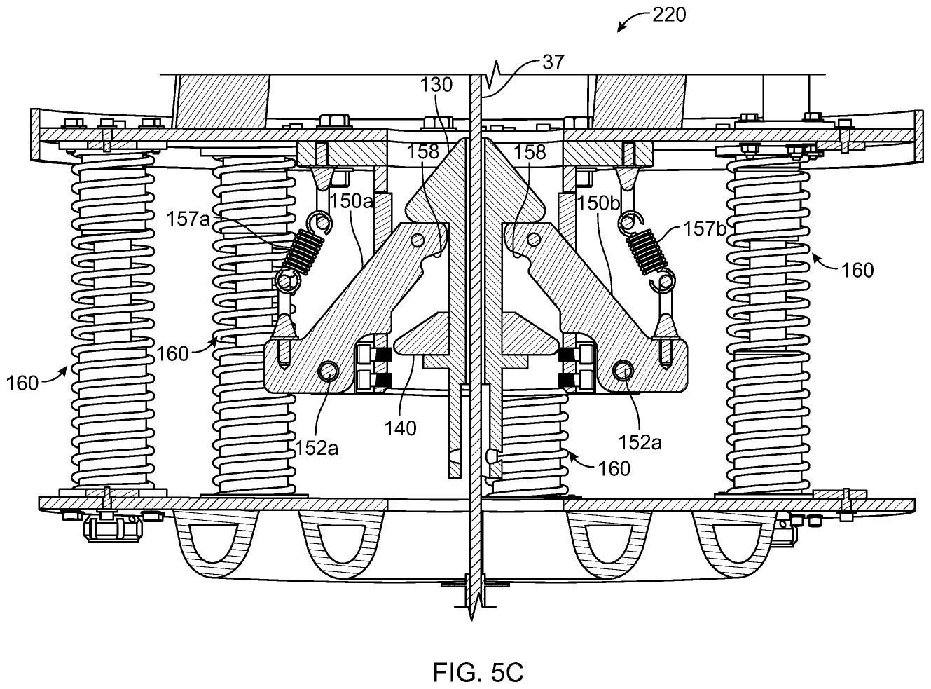

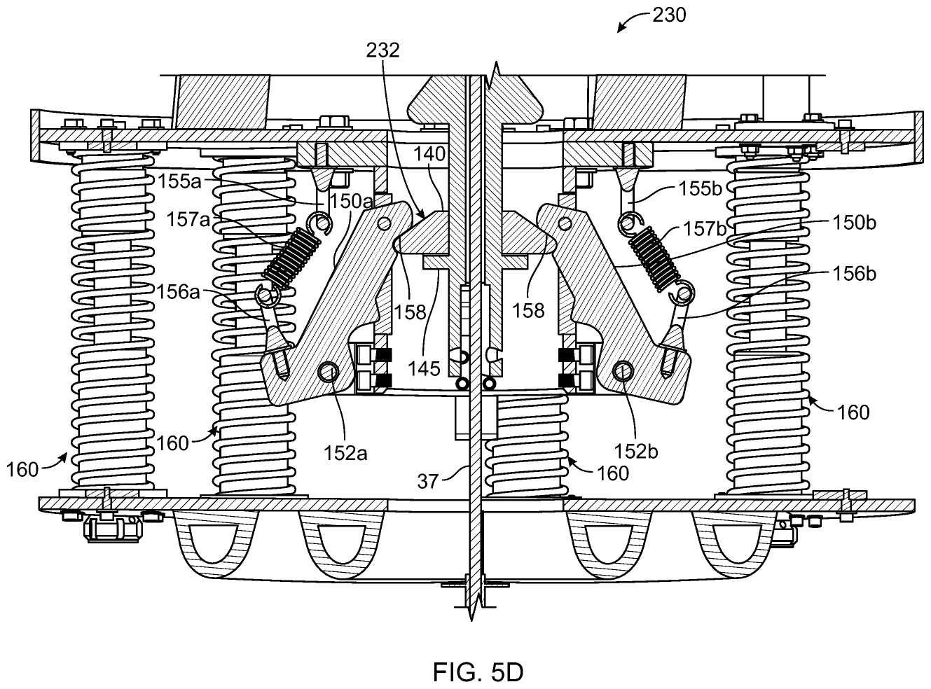

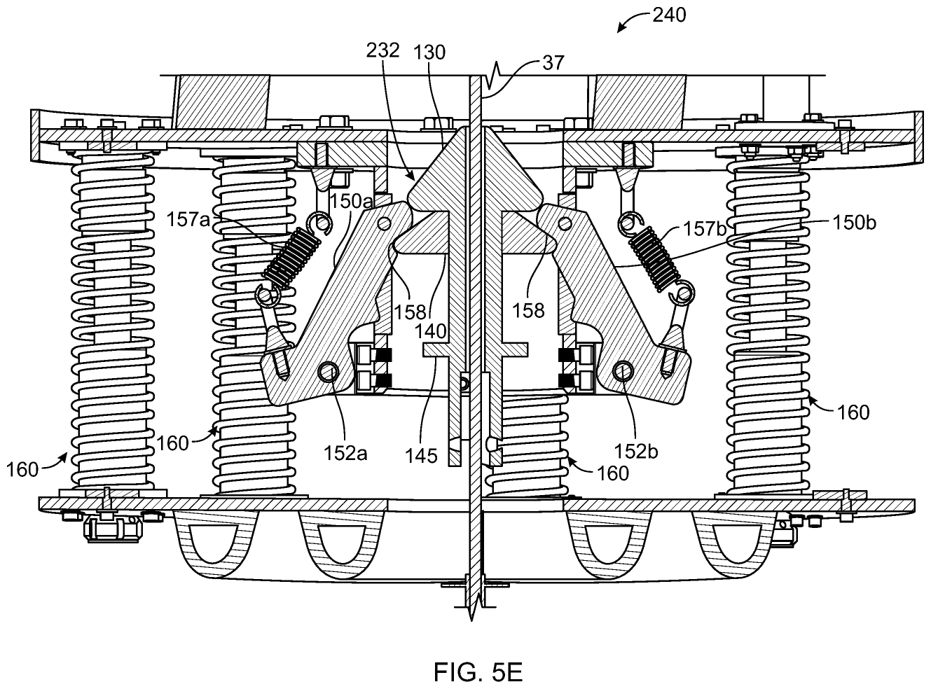

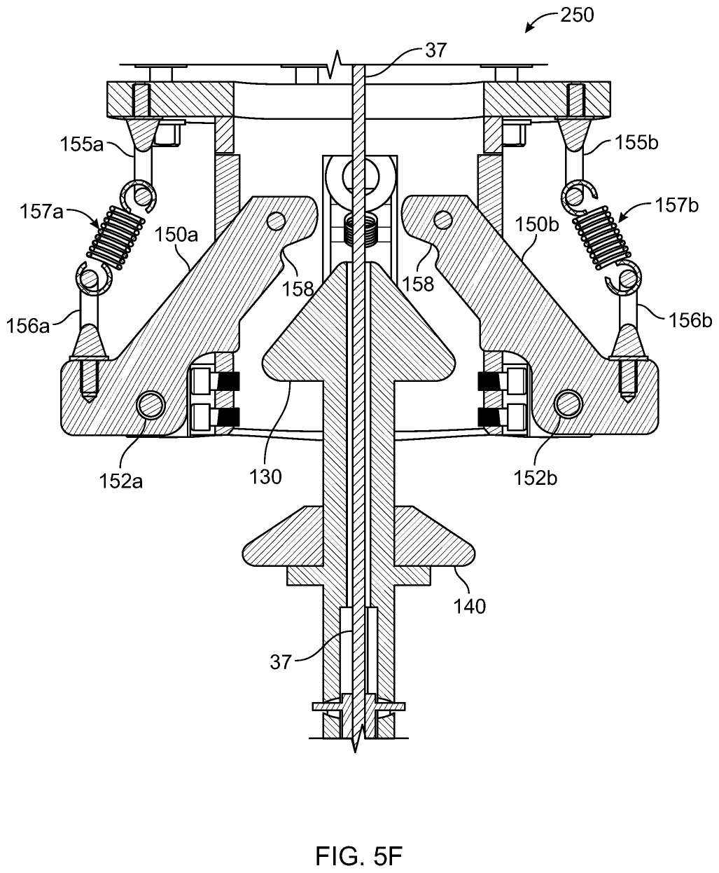

Reference is next made to FIG. 2 and FIGS. 3A to 3F which shows a latching device or mechanism 100 according to an embodiment of the present invention. The latching mechanism 100 comprises a latch housing 110, a bullet assembly 120, a bullet 130, a sliding block 140, and two or more latch fingers 150, indicated individually by references 150a and 150b in FIGS. 3E and 3F. According to an exemplary implementation, the latch house 110 comprises four latch fingers, indicated individually by references 150a, 150b, 150c and 150d as shown in FIG. 3A. The bullet assembly 120, as shown in FIG. 2, comprises the bullet 130 having a generally ‘mushroom-shaped’ head indicated by reference 132, a shaft 135 comprising a longitudinal or cylindrical section, and a terminal end indicated by reference 134, which is configured to connect to the load 22, e.g. marine or industrial equipment, for example, using a pin and a U-bolt. The sliding block 140 is mounted on a section of the bullet 130 and is configured to float, i.e. move, between a first position 141 (e.g. a lower position 141) and a second position 143 (e.g. an upper position) along the shaft or cylindrical section 135. The first position 141 is defined by a restraint comprising a flange 145, and the second position 142 is defined by a lower surface 133 of the bullet head 132 which acts as a restraint on the further movement of the sliding block 140. As shown, the sliding block 140 comprises two halves 142, indicated individually by references 142a and 142b, with one half of the sliding block 140 being shown in FIG. 3D and indicated by reference 142a. The sliding block half 142a is configured with two bolt holes 144, indicated individually by references 144a and 144b, which receive respective threaded bolts that are screwed into respective threaded sockets 147a and 147b in the other half of the sliding block 142b shown in FIG. 3B. As shown in FIG. 2, the latch fingers 150 are coupled to the latch housing 110 using respective pins or shafts 152, indicated individually by references 152a and 152b. The pins 152 are configured to allow the latching fingers 150 to pivot or move between a latched position and an unlatched position (or for example, a resting position) indicated by respective arc lines 153a and 153b. According to an exemplary embodiment and as shown in FIG. 2, the latch housing 110 may include bias spring hooks 155, indicated individually by references 155a and 155b, each configured for connecting one end of a biasing spring 157a and 157b (FIG. 3A), respectively, the other end of the bias springs 157 is connected to a spring hook or clip 156, indicated individually by references 156a and 156b (FIG. 3A). The springs 157 provide a biasing force to maintain the respective latch fingers 150 in a closed or engaged position as shown in FIG. 5, as will be described in more detail below. According to an exemplary embodiment, the latch device 100 includes four latching fingers 152a, 152b, 152c and 152d configured with a respective biasing springs 157a, 157b, 157c and 157d, as shown in FIG. 3A. It will be appreciated that other biasing mechanisms may be utilized to provide positional bias to the latching fingers.

Referring to FIGS. 3E and 3F, each of the latching fingers 150 includes an upper groove indicated generally by reference 158 and a shoulder indicated generally by reference 159. The upper groove 158 is formed or machined in the latch finger 150 and configured to receive the block 140 during operation of the latching device 100 as described in more detail below. According to an exemplary implementation, the groove 158 in the latching finger 150 is machined into a contour that allows the block 140 to be securely seated. In other embodiments or implementations, the sliding block 140 is formed or machined from a harder or less wearing material, or metal or metallic material. The shoulder 159 is formed or machined in the lower section of the latch finger 150 and is configured to provide a “resting position”. As described above, each of the latch fingers 150 pivots or rotates about the respective pin 152.

Referring back to FIG. 2, the shaft or cylindrical section 135 of the bullet 130 in the bullet assembly 120 includes a bore or passageway indicated generally by reference 122. The bore 122 is configured to allow the tension member 37 to pass through the bullet 130 to the terminal end 134 and connect to the load 22, e.g. marine equipment. Through the operation of the tension member 37 (and the winch 36) and the bullet assembly 120, the latching mechanism 100 is latched/unlatched and the marine equipment 22 is raised/lowered from the ship deck 21 to the water or to a platform or a pier or loading dock, for example, as will be described in more detail with reference to drawing, in particular, to FIGS. 4A to 4D and FIGS. 5A to 5F.

As shown in FIG. 4A, the bullet assembly 120 is secured or connected to the load (e.g. equipment) 22. The operator 11 utilizes a control panel 13 to activate the cable spindle and drive mechanism or winch 36 to wind (or retrack) the tension member (e.g. a cable) 37 and lift the load 22 and move the bullet assembly 120 up and into the latch housing 110. During the operation, the tension member 37 is under tension as depicted in FIG. 4A. As the load equipment 22 is raised, the bullet assembly 120 pushes against the latch fingers 150 and the bias of the springs 157 to an open position as indicated by reference 210 in FIG. 5B and through the opening formed between the latch fingers 150. Once the bullet assembly 120 passes through the opening, the latch fingers 150 move to a closed or latching position as indicated by reference 220 in FIG. 5C, i.e. under the force of the bias springs 157. As shown in FIG. 5C, the bullet assembly 120 rests on respective upper surfaces 151 of the latch fingers 150. According to an embodiment, the upper surfaces 151 of the latch fingers 150 are machined or formed as substantially flat surfaces to mate with the underside or lower surface 133 of the bullet 130 and support and/or distribute the force applied by the bullet 130. The springs 157 bias the latch fingers 150 against the shaft or barrel of the bullet assembly 120, and the bullet assembly 120 is latched or coupled to the latch housing 110. Once in the latched position 220, the cable drive mechanism 36 is actuated (e.g. by the operator) to remove the tension from the tension member 37 (i.e. extend or unwind the tension member 37) and the tension member 37 is slack as depicted in FIG. 4B. Through the operation of the lift 30 and the beam arm 32, the equipment is raised above the deck 21 of the ship 20 as shown in FIG. 4B, and then moved laterally over the side of the ship deck 21 and lowered towards the water (or a platform, or a pier), for example, as depicted in FIG. 4C.

To unlatch the latching device 100 and allow the equipment 22 to be lowered as shown in FIG. 4D, the operator 11 actuates the cable drive mechanism 36 to put tension in the tension member 37 (i.e. rewind or retrack the tension member 37) and move the bullet assembly 120 into an unlatching position 230 as shown in FIG. 5D. As shown in FIG. 5D putting tension on the tension member 37 (utilizing the winch 36), raises the equipment 22 and also moves the bullet assembly 120 upwards and the sliding block 140 (positioned on the flange 145) moves upwards until the sliding block 140 is engaged in the upper groove 158 formed in the latch fingers 150, and into an unlatching position indicated by reference 230. The compression springs 160 are configured to dampen motion of the equipment or load 22 as it is being moved or maneuvered. According to an exemplary implementation, the compression springs 160 can also be configured with a stopper that restricts or limits full compression of the respective compression spring 160. The compression springs 160 are configured to compress to a length or span sufficient for the bullet assembly 120 to move between the latching and unlatching positions as described above, and also act as stoppers to limit and prevent the bullet assembly 120 and the sliding block 140 from moving further in the upward direction, e.g. exiting or moving through the top of the latch housing 110. In the unlatched position 230, the sliding block 140 functions to open the latch fingers 150 to a position that provides a passageway indicated by reference 232 of sufficient diameter or width to allow the bullet head 130 to pass back through the opened latch fingers 150 as shown in FIG. 5E, when the tension member 37 is lowered or unwound as shown in FIG. 4D. The equipment 22 can be lowered to a platform for unloading and disconnecting from the bullet assembly 120. As shown in FIG. 5F, as the bullet assembly 120 passes through the opened latching fingers 150 and the bullet 130 functions to press against the sliding block 140 and disengage the block 140 from the upper groove 158 in the latch fingers 150. Once disengaged from the groove 158, the sliding block 140 moves or slides to the lower position and is supported by the flange 145 at the lower end 141 of the bullet assembly 120 as also shown in FIG. 5F.

In operation, the latching device or mechanism 100 provides the functionality to secure equipment 22 and move the equipment 22 with a lift or crane from a ship deck 21 to the water or another platform and back to the deck 21 of the ship 20. The latching mechanism 100 is mechanically actuated through the motion of the lift device 30, and according to an exemplary embodiment without the need for additional actuation, for instance, locking, holding or other actuation input from a separate source or device. According to one aspect, the configuration of the latching device 100 securely connects the equipment to the winch 36 while being lowered and provides a secure coupling to reduce the likelihood of the equipment being dropped damaging the equipment 22 and/or deck 21 of the ship 20. As described above, the tension member 37 is held in tension by the winch 36 to actuate the latching and the unlatching of the latching device 100, which means that the equipment or load 22 is held securely and cannot be dropped once latched. The latching/unlatching of the latch device 100 comprises mechanical operations which are native to the operation of the lift 30 and the winch 36. This eliminates the need to rely on the actuation of hydraulics through signals, or other inputs, which can lead to malfunctions. In addition, the mechanical actuation of the latching device 100 using lowering and raising operations native to the operation of the lift 30 and the winch 36 can reduce the training required for an operator. In addition, safety can be improved because less personnel are needed in the vicinity or proximity of the lift device 30 and/or the equipment 22.

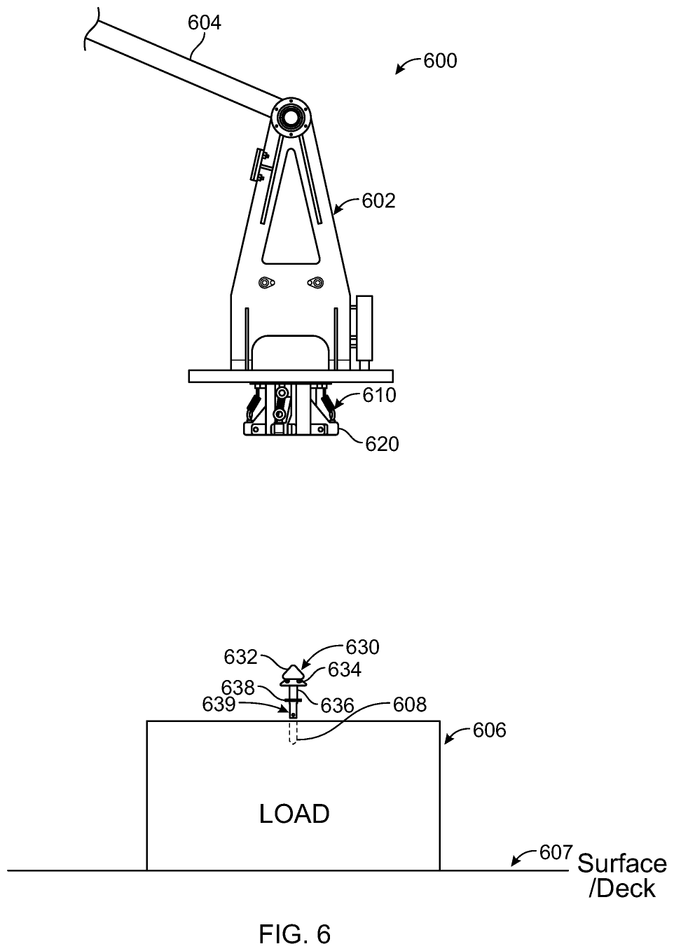

Reference is next made to FIG. 6, which shows a latching mechanism and configuration according to another embodiment of the present invention and indicated generally by reference 600. As shown, the latching mechanism 610 comprises a latch housing 620 and a bullet indicated by reference 630. The bullet 630 has a configuration similar the bullet 130 as described above, and comprises a bullet head 632, a sliding block 634, a shaft 636 and a terminal or lower flange end 638 The latch housing 620 is coupled or connected to a lifting or docking head indicated generally by reference 602. The latch housing 620 has a configuration similar to the latch housing 110 as described above. The lifting or docking head 602 is coupled to a lift arm or boom indicated generally by reference 604. The arm 604 may comprise, for example, a robotic lift arm (in a manufacturing or factory application) or a crane boom. According to the embodiment, the bullet 630 is attached or connected directly to a load indicated by reference 606. The bullet 630 can be attached permanently or non-permanently to the load 606. For instance if the load 606 comprises equipment that is moved or re-positioned on an ongoing basis in an industrial plant, the connection of the bullet 630 can be permanent. If the load 606 comprises multiple modules or pieces of equipment, then the bullet 630 can be attached or connected in a non-permanent manner, for instance, the bullet 630 is configured with a threaded section 632 on the shaft 636 below the lower flange 638 that screws into a threaded socket 608 in the load 606.

In operation, the load 606 sits or is supported on a surface 607, e.g. a factory floor, until the latch housing 620 latches the bullet 630. The lift arm 604, i.e. a robotic arm, lowers the lifting head 602 and the connected latch housing 620 onto the bullet 630 to latch or couple the bullet 630, in a manner similar to that described above. Once latched, the load 606 can be lifted or moved by the robotic arm 604. To unlatch the load 606, the robotic arm 604 lowers the load onto the surface 607 and the robotic arm 604 lowers the latch housing 620 further to move the latching mechanism into the unlatching position to disengage the bullet 630 from the latch housing 620, in manner similar to that described above. It will be appreciated that the latching mechanism and configuration 600 eliminates the need for a tension member, e.g. a cable, to actuate the latching mechanism 610 for engaging/disengaging the bullet 630 and the coupled load 606.

The present invention may be embodied in other specific forms without departing from the spirit or essential characteristics thereof. Certain adaptations and modifications of the invention will be obvious to those skilled in the art. Therefore, the presently discussed embodiments are considered to be illustrative and not restrictive, the scope of the invention being indicated by the appended claims rather than the foregoing description, and all changes which come within the meaning and range of equivalency of the claims are therefore intended to be embraced therein.

### LIST OF REFERENCE NUMERALS

10—exemplary operating environment comprising a ship or vessel
20—ship or vessel
21—ship deck or platform
22—load for example, marine equipment, or industrial equipment
30—recovery lift or crane
32—extendible lift arm or beam for recovery lift or crane
34—terminal end of the extendible lift arm
35—docking head
36—cable spindle and drive or winch mechanism
37—tension member
38—sheave pulley or cable guide
100—latching device or mechanism
110—latch housing
120—bullet assembly
122—bore hole in the bullet shaft
130—bullet
132—mushroom-shape head for the bullet
133—lower surface or underside of the bullet
135—shaft or cylindrical section of the bullet
140—sliding block
141—first position or lower position
143—second position or upper position
144—bolt holes or apertures
145—flange for supporting bronze block in the first or lower position on the bullet
147—threaded socket or bore holes
150—latch fingers
152—pins for securing and pivoting the latching fingers
153—movement path or arc of the latching fingers between latched/unlatched positions
155—latch housing spring clips or hooks
156—latching finger spring clips or hooks
157—latching finger biasing springs
158—upper groove in latching finger
159—shoulder in latching finger for resting position
160—external compression springs
600—latching mechanism and configuration according to another embodiment
602—lifting or docking head
604—lift arm, robotic arm or crane boom
606—load or equipment
607—support surface, floor or platform
608—threaded socket in the load
610—latching mechanism
620—latch housing
630—bullet
632—bullet head
634—sliding block
636—shaft
638—terminal or lower flange end
639—threaded section on the shaft of the bullet

What is claimed is:

1. A latching mechanism coupled to a lift and configured for maneuvering a load, said latching mechanism comprising:
a latch housing, said latch housing comprising a plurality of latch fingers, said latch fingers being configured to move between an open position and a closed position;
a bullet assembly, said bullet assembly comprising a shaft, a bullet head and a terminal end, said bullet head being connected to one end of said shaft and said terminal end being connected to the other end of said shaft, and said terminal end being configured to connect to the load;
a block, said block being configured to move along said shaft of said bullet assembly between a first position and a second position;
each of said latch fingers including a groove, said groove being configured for receiving and holding at least a portion of said block in said second position;
said bullet assembly being configured to couple to a tension member, and said tension member being configured to raise and lower said bullet assembly under an applied tension;
said bullet head being configured to engage said plurality of latch fingers in a latched mode in response to said applied force on said bullet assembly;
said bullet assembly being responsive to a further applied tension to move said block into said second position and engage said groove in said plurality of latch fingers and move said plurality of latch fingers into said open position; and
in said open position said latch fingers being configured to allow said bullet head to pass and said block to disengage from said groove and move into said first position, and into an unlatched mode, so that the load attached to said cable can be maneuvered by the lift.

2. The latching mechanism as claimed in claim 1, wherein said latch housing further includes a bias spring for each of said plurality of latch fingers, each of said bias springs being configured to bias each of said plurality of latch fingers in said closed position.

3. The latching mechanism as claimed in claim 2, wherein said latch housing further includes one or more compression springs, said one or more compression springs being configured to compress and limit movement of said block to said second position under application of said further applied tension.

4. The latching mechanism as claimed in claim 2, wherein said tension member is installed on a winch and said winch is configured to apply tension to said tension member in response to control by an operator.

5. The latching mechanism as claimed in claim 4, wherein said upper groove in said plurality of latch fingers comprises a contour configured to securely engage said block.

6. The latching mechanism as claimed in claim 2, wherein said cable is installed on a winch and said winch is configured to apply tension to said tension member in response to control by an operator.

7. The latching mechanism as claimed in claim 6, wherein said block comprises a contour configured to conform to the shape of said upper groove in said plurality of latch fingers.

8. An industrial lift configured for lifting/lowering a load, said industrial lift comprising:
a lift arm, said lift arm being operatively coupled to a lift mechanism for lowering and raising said lift arm;
a drive mechanism configured for unwinding and rewinding a tension member;
a docking head operatively coupled to one end of the lift arm and being connected to said tension member;
said drive mechanism being responsive to one or more control signals for extending/retracking said tension member and for controlling tension and slack in said tension member;
a latching mechanism, said latching mechanism including,
a latch housing, said latch housing comprising a plurality of latch fingers, said latch fingers being configured to move between an open position and a closed position;
a bullet assembly, said bullet assembly comprising a shaft, a bullet head and a terminal end, said bullet head being connected to one end of said shaft and said terminal end being connected to the other end of said shaft, and said terminal end being configured to connect to the load;
a block, said block being configured to move along said shaft of said bullet assembly between a first position and a second position;
each of said latch fingers including a groove, said groove being configured for receiving and holding at least a portion of said block in said second position;
said bullet assembly being configured to couple to said tension member, and said tension member being configured to raise and lower said bullet assembly under an applied tension;
said bullet head being configured to engage said plurality of latch fingers in a latched mode in response to said applied force on said bullet assembly;
said bullet assembly being responsive to a further applied tension to move said block into said second position and engage said groove in said plurality of latch fingers and move said plurality of latch fingers into said open position; and
in said open position said latch fingers being configured to allow said bullet head to pass and said block to disengage from said groove and move into said first position, and into an unlatched mode.

9. The latching mechanism as claimed in claim 8, wherein said latch housing further includes a bias spring for each of said plurality of latch fingers, each of said bias springs being configured to bias each of said plurality of latch fingers in said closed position.

10. The latching mechanism as claimed in claim 9, wherein said latch housing further includes one or more compression springs, said one or more compression springs being configured to compress and limit movement of said block to said second position under application of said further applied tension.

11. The latching mechanism as claimed in claim 9, wherein said cable is installed on a winch and said winch is configured to apply tension to said tension member in response to control by an operator.

12. The latching mechanism as claimed in claim 11, wherein said upper groove in said plurality of latch fingers comprises a contour configured to securely engage said block.

13. The latching mechanism as claimed in claim 9, wherein said cable is installed on a winch and said winch is configured to apply tension to said tension member in response to control by an operator.

14. The latching mechanism as claimed in claim 13, wherein said block comprises a contour configured to conform to the shape of said upper groove in said plurality of latch fingers.

15. A latching mechanism coupled to a lift arm and configured for maneuvering a load, said latching mechanism comprising:
a lifting head, said lifting head being operatively coupled to the lift arm;
a latch housing, said latch housing being coupled to said lifting head, and comprising a plurality of latch fingers, said latch fingers being configured to move between an open position and a closed position;
a bullet assembly, said bullet assembly comprising a shaft, a bullet head and a terminal end, said bullet head being connected to one end of said shaft and said terminal end being connected to the other end of said shaft, and said terminal end being configured to connect to the load;
a sliding block, said sliding block being configured to move along said shaft of said bullet assembly between a first position and a second position;
each of said latch fingers including a groove, said groove being configured for receiving and holding at least a portion of said block in said second position;
said bullet assembly being configured to connect to the load;
said bullet head being configured to engage said plurality of latch fingers in a latched mode in response to said lifting head and said latch housing being lowered onto said bullet assembly;
said bullet assembly being responsive to a further movement of said latch housing and said lifting head to move said sliding block into said second position and engage said groove in said plurality of latch fingers and move said plurality of latch fingers into said open position; and
in said open position said latch fingers being configured to allow said bullet head to pass and said sliding block to disengage from said groove and move into said first position, and into an unlatched mode.

16. The latching mechanism as claimed in claim 15, wherein said latch housing further includes a bias spring for each of said plurality of latch fingers, each of said bias springs being configured to bias each of said plurality of latch fingers in said closed position.

17. The latching mechanism as claimed in claim 16, wherein said latch housing further includes one or more compression springs, said one or more compression springs being configured to compress and limit movement of said sliding block to said second position.

18. An industrial lift configured for lifting/lowering a load, said industrial lift comprising:
a lift arm, said lift arm being operatively coupled to a lift mechanism for lowering and raising said lift arm;
a lifting head operatively coupled to one end of the lift arm and being connected to said tension member;
said lift mechanism being responsive to one or more control signals for lowering and raising said lift arm;
a latch housing, said latch housing being coupled to said lifting head, and comprising a plurality of latch fingers, said latch fingers being configured to move between an open position and a closed position;
a bullet assembly, said bullet assembly comprising a shaft, a bullet head and a terminal end, said bullet head being connected to one end of said shaft and said terminal end being connected to the other end of said shaft, and said terminal end being configured to connect to the load;
a sliding block, said sliding block being configured to move along said shaft of said bullet assembly between a first position and a second position;
each of said latch fingers including a groove, said groove being configured for receiving and holding at least a portion of said block in said second position;
said bullet assembly being configured to connect to the load;
said bullet head being configured to engage said plurality of latch fingers in a latched mode in response to said lifting head and said latch housing being lowered onto said bullet assembly;
said bullet assembly being responsive to a further movement of said latch housing and said lifting head to move said sliding block into said second position and engage said groove in said plurality of latch fingers and move said plurality of latch fingers into said open position; and
in said open position said latch fingers being configured to allow said bullet head to pass and said sliding block to disengage from said groove and move into said first position, and into an unlatched mode.

19. The latching mechanism as claimed in claim 18, wherein said latch housing further includes a bias spring for each of said plurality of latch fingers, each of said bias springs being configured to bias each of said plurality of latch fingers in said closed position.

20. The latching mechanism as claimed in claim 18, wherein said latch housing further includes one or more compression springs, said one or more compression springs being configured to compress and limit movement of said sliding block to said second position.
